(19) United States
(12) Patent Application Publication
(10) Pub. No.: US 2002/0137649 A1
(43) Pub. Date: Sep. 26, 2002

(54) Mechanical warewashing compositions containing scale inhibiting polymers with targeted rinse cycle delivery

(76) Inventors: Joseph Oreste Carnali, Pompton Plains, NJ (US); Yan Zhou, Montville, NJ (US)

Correspondence Address: UNILEVER, PATENT DEPARTMENT, 45 RIVER ROAD, EDGEWATER, NJ, 07020, US

(21) Appl. No.: 09/758,685

(22) Filed: Jan. 11, 2001

Related U.S. Application Data
(60) Provisional application No. 60/210,914, filed on Jun. 12, 2000.

(51) Int. Cl. C11D 1/00

(52) U.S. Cl. 510/220; 510/229; 510/230; 510/475

(57) ABSTRACT

A mechanical dishwashing composition and related method are provided wherein the composition includes an anti-scaling polymer formed mostly from an olefinically unsaturated carboxylic acid monomer in combination with a minor amount of at least one copolymerizable sulfonated monomer or copolymerizable nonionic monomer, and a vehicle releasing at least an effective amount of the polymer into a penultimate rinse of a dishwashing cycle to prevent scaling. Most preferred is a composition and method releasing the anti-scaling polymer not only into the penultimate but also the final rinse cycle.

### BACKGROUND OF THE INVENTION

1. Field of the Invention

This invention pertains to dose profile engineered delivery of scale inhibiting polymers to control calcium phosphate scale in the rinse cycle of a machine dishwashing process.

2. The Related Art

The machine dishwashing process comprises washing articles in a main wash cycle and rinsing them in one or more rinse cycles. A rinse cycle composition is traditionally designed to function in the final rinse step of the machine dishwashing operation, separate from the function of the detergent composition used in the main wash cycle. The rinse cycle composition's performance is judged particularly by its ability to prevent spot and film formation on washed articles. Rinse cycle compositions can often comprise an aqueous liquid containing a low-foaming nonionic surfactant, hydrotropes and an ingredient such as citric acid that can act as a builder and a pH control agent. This liquid is automatically dosed into the last (final) of the dishwashers rinse cycles. Alternatively, the composition can be introduced into the washing machine along with or as part of the main wash detergent composition—as long as its dissolution into the water can be delayed until the final rinse cycle.

For many years, sodium tripolyphosphate (STP) has been used in the main wash detergent composition for machine dishwashing operations as the primary detergency builder to sequester water hardness ions (Ca²⁺, Mg²⁺). However, precipitation of STP by hardness ions can occur under underbuilt conditions which arise when an insufficient amount of STP is present in high hardness water. This situation can result in calcium phosphate deposition (scaling) on washed article surfaces. The tendency of scaling with some slow-dissolving tablet main wash products is even higher because, during the course of tablet dissolution, the wash liquor can be underbuilt if relatively high levels of hardness ions are present. The dissolution profile of the tablet is such that, in the initial stages of the wash, only part of the available phosphate will be delivered to the wash water. In addition, underdosage of other forms of product, such as liquids, powders, granulates and gels, can also cause a comparable scaling problem.

A separate problem arises from wash liquor containing STP being carried over from the main wash cycle into the rinse cycles. This carry-over results in an underbuilt or supersaturated rinse water under hard water conditions, and can lead to further scale deposition on the articles or to a reduction in the ability of the rinse water to remove previous deposition. Usually, there is a build up of scale and this deposition causes an objectionable filming, especially on glassware surfaces. Increasing temperature and water hardness increases scaling dramatically.

WO 95/32271 describes terpolymers containing carboxylic acid, 2-alkylallyl sulfonic acid and a carbohydrate derived from sugar for use in rinsing agents for dishwashing machines to prevent the formation of spots on washed articles.

DE 44 15 804 describes terpolymers containing acrylic acid, maleic acid and vinyl alcohol and/or vinyl acetate for use in rinsing agents for dishwashing machines to prevent the formation of spots on dried crockery, glassware and cutlery.

Biodegradable copolymers of itaconic acid and vinyl alcohol or vinyl acetate have been described in WO 94/17170 for incorporation in machine dishwashing and rinse aid compositions to prevent lime scale.

EP 851 022 describes a rinse aid composition incorporating scale inhibiting polymers particularly effective for machine dishwashing. These polymers contain 50-99% by weight of an olefinically unsaturated carboxylic acid monomer and 1-50% of at least one monomer selected from a copolymerizable sulfonated monomer, copolymerizable nonionic monomer or combinations thereof. While these inhibitors have advanced the art, there remains an unfulfilled need in rendering the systems yet more efficient.

Accordingly, it is an object of the present invention to control scaling in the machine dishwashing process, especially scaling arising from washing from underbuilt detergents in high water hardness systems.

It is yet another object of the present invention to deliver scale inhibitors in a sequence effective for controlling calcium/STP scale in the machine dishwashing process.

### SUMMARY OF THE INVENTION

A mechanical dishwashing composition is provided which includes:

(A) an anti-scaling polymer formed from

(i) 50-99% by weight of the polymer of an olefinically unsaturated carboxylic acid monomer;

(ii) 1 to 50% of at least one monomer unit selected from the group consisting of copolymerizable sulfonated monomers, copolymerizable nonionic monomers and mixtures thereof;

(B) 0.1 to 99.9% of a vehicle releasing at least an effective amount of the polymer into penultimate and final rinse cycles of a dishwashing sequence to prevent scaling.

Further, there is provided a method for washing soiled dishes which includes charging a mechanical dishwashing composition to a wash liquor of a washing machine, the composition including:

(A) an anti-scaling polymer formed from

(i) 50-99% by weight of the polymer of an olefinically unsaturated carboxylic acid monomer;

(ii) 1 to 50% of at least one monomer unit selected from the group consisting of copolymerizable sulfonated monomers, copolymerizable nonionic monomers and mixtures thereof;

(B) 0.1 to 99.9% of a vehicle releasing at least an effective amount to prevent scaling of the polymer into penultimate and final rinse cycle of a dishwashing sequence to prevent scaling.

Generally the wash program of a machine dishwasher involves a sequence of water fill, wash/rinse and water drain cycles which are automatically performed by the machine without operator intervention. It has now been discovered that optimum performance from scale inhibitors of this invention is obtained when the inhibitors are released in the penultimate rinse. Even more preferable is the presence of the inhibitor in both the penultimate and the final rinse cycles of the wash program (especially when present on comparable levels). This finding contrasts with historic practice in this art of dosing scale inhibitors via rinse cycle compositions added only to the final rinse cycle. It is not generally appreciated that any component of the role of a rinse cycle composition can be efficiently performed from other than the final rinse cycle.

### BRIEF DESCRIPTION OF THE DRAWING

Further objects, features and advantages of the present invention will more readily be understood with reference to the drawing in which:

FIG. 1 is a schematic illustration of a typical machine dishwashing program showing the water usage and temperature profile of the sequential cycles;

FIG. 2 is a plot of the scale inhibitor concentration profile delivered by a core tablet into the pre-rinse and final rinse (the core tablet contained 0.35 g of Alcosperse® 240 and 0.15 g of Pluronic® F108);

FIG. 3 is a plot of the scale inhibitor concentration profile delivered by a core tablet into the pre-rinse and final rinse (the core tablet contained 0.35 g of Alcosperse® 240 and 0.15 g of Tetronic® 1107); and

FIG. 4 is a plot of the scale inhibitor concentration profile delivered by a solid block into the pre-rinse and final rinse (the block contained 9.1% of Alcosperse® 240).

### DETAILED DESCRIPTION OF THE INVENTION

The compositions of the invention can be formulated in any desired form such as solids, tablets, powders, granulates, pastes, liquids and gels and combinations thereof. Regardless of the form chosen, it is critical to this invention that the form allow for the preferred rinse cycle composition dosage into at least the penultimate or, preferably, both penultimate and final rinse cycles.

### Scale Inhibitors

An important component of the compositions in accordance with the invention is a scale-inhibiting polymer. This polymer comprises about 50 to about 99%, preferably from about 70 to about 98%, most preferably from about 75 to about 95% by wt. of the polymer of an olefinically unsaturated carboxylic acid monomer and about 1 to about 50%, preferably from about 2 to about 30%, most preferably from about 5 to about 25% by wt. of the polymer of at least one monomer unit selected from

(a) copolymerizable sulfonated monomers,

(b) copolymerizable nonionic monomers or

(c) mixtures of (a) and (b).

The olefinically unsaturated carboxylic acid monomer for use herein is intended to include C₃-C₄₀ branched or cyclic, mono- or dicarboxylic acids, the alkali or alkaline earth metal or ammonium salts thereof, and the anhydrides thereof. Useful olefinically unsaturated acids of this class include acrylic acid co-monomers typified by acrylic acid itself, methacrylic acid, ethacrylic acid, alpha-chloro-acrylic acid, alpha-cyano acrylic acid, beta methyl-acrylic acid (crotonic acid), alpha-phenylacrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, and tricarboxyethylene.

For the polycarboxylic acid monomers, an anhydride group is formed by the elimination of one molecule of water from two carboxyl groups located on the same polycarboxylic acid molecule. Preferred carboxylic monomers for use in this invention are the monoolefinic acrylic acids having a substituent selected from the class consisting of hydrogen, halogen, hydroxyl, C₁-C₂₀ alkyl, C6-C₁₂ aryl, C6-C₁₆ aralkyl, C₇-C₁₆ alkaryl radicals and C₅-C₁₆ cycloaliphatic radicals. As used herein, (meth) acrylic acid is intended to include acrylic acid and methacrylic acid. Preferred unsaturated carboxylic acid monomers are acrylic and methacrylic acid, more preferably acrylic acid.

Examples of sulfonate monomers (a) include, but are not limited to, allyl hydroxypropanyl sulfonate ether, allylsulfonic acid, methallylsulfonic acid, styrene sulfonic acid, vinyl toluene sulfonic acid, acrylamido alkane sulfonic acid, allyloxybenzene sulfonic acid, 2-alkylallyloxybenzene sulfonic acid(s) such as 4-sulfophenol methallyl ether, and the alkali or alkaline earth metal or ammonium salts thereof.

The copolymerizable nonionic monomers (b) are vinyl or allyl compounds selected from the group consisting of C₁-C₆ alkyl esters of (meth)acrylic acid, acrylamide and the C₁-C6 alkyl-substituted acrylamides, the N-alkyl-substituted acrylamides and the N-alkanol-substituted acrylamides, N-vinyl pyrrolidone or any other vinyl amide. Also useful are the C₁-C₆ alkyl esters and C₁-C₆ alkyl half-esters of unsaturated vinylic acids, such as maleic acid and itaconic acid. Preferred nonionic monomers are selected from the group consisting of methyl (meth)acrylate, mono- and dimethyl maleate, mono- and di-ethyl itaconate, and (meth)allyl acetates, propionates and valerates. Particularly preferred is methyl methacrylate. Minor amounts of crosslinking monomers such as diallyl maleate, alkylene bisacrylamide and triallyl cyanurate may also be employed herein.

For definitional purposes, the term “acid” includes not only the acid function but also respective anhydride and salt forms. The salts may be alkali metal, alkaline earth metal, ammonium and C₂-C₁₀ alkanolammonium types.

The weight average molecular weight of the polymers ranges from about 1500 to about 250,000, preferably from about 5,000 to about 100,000.

A suitable example of a scale-inhibiting copolymer includes, but is not limited to, a tetrapolymer of 4-sulfophenol methallyl ether, sodium methallyl sulfonate, acrylic acid and methyl methacrylate. The monomer unit, sulfophenol methallyl ether, has a formula (I):

CH₂=C(CH₃)CH₂OC₆H₄SO₃M (I)

where M represents hydrogen, alkali metal, alkaline earth metal or ammonium ions.

Other suitable examples of scale-inhibiting copolymers include, but are not limited to, a copolymer of acrylic acid and 4-sulfophenol methallyl ether; a copolymer of acrylic acid and 2-acrylamido-2-methylpropane sulfonate; a terpolymer of acrylic acid, 2-acrylamido-2-methylpropane sulfonate and sodium styrene sulfonate; a copolymer of acrylic acid and vinyl pyrrolidone; and a copolymer of acrylic acid and acrylamide. Preferably, the polymer is the tetrapolymer of 4-sulfophenol methallyl ether, sodium methallyl sulfonate, acrylic acid and methyl methacrylate.

Preferred commercially available copolymers include: Alcosperse® 240, Aquatreat® AR 540 and Aquatreat® MPS supplied by Alco Chemical; Acumer® 3100, Acumer® 2100 and Acumer® 2000 supplied by Rohm & Haas; Goodrich K-798, K-775 and K-797 supplied by BF Goodrich; ACP 1042 supplied by ISP technologies Inc.; and polyacrylic acid/acrylamide supplied by Aldrich. A particularly preferred copolymer is Alcosperse® 240 supplied by Alco Chemical.

### Optimum Dosing Profile

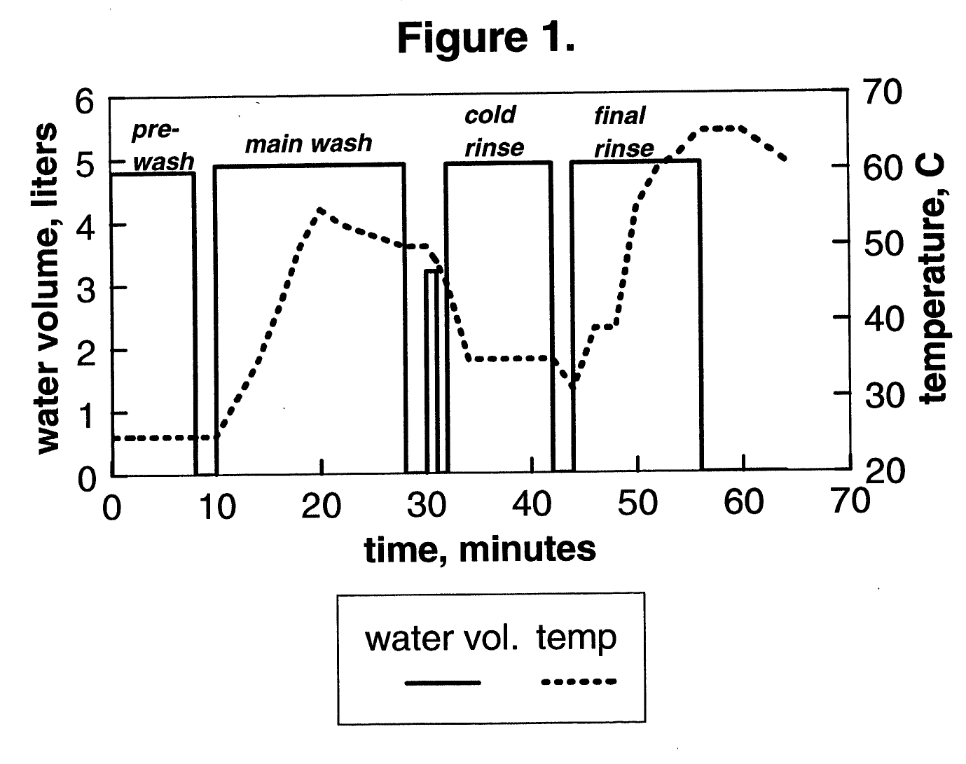

Machine dishwashing is carried out through a series of sequential cycles, each with its own special function. A typical wash program is schematically illustrated in FIG. 1, redrawn from “Prüfmethoden zur Bestimmung der Leistung von Klarspülern für das maschinelle Gerschirrespülen”, by W. Schirmer, Th. Altenschöpfer, W. Wichelhaus and H. Andree, in Tenside Surfactants Detergents, volume 28, pages 313-319 (1991). The program consists of a sequence of machine fillings with specified amounts of water, heating of this water to predetermined levels, spray-on of the water to glasses and plates for a period of time and then drainage of the water prior to the next cycle. A small portion (about 1 to 30%, but optimally about 10%) of the drained water is retained between cycles and carries over to the subsequent cycle. In the pre-wash cycle, cold water without detergent is used to remove loosely held food residues from the wash environment. The following main wash provides an opportunity for the majority of washing action to occur under elevated temperature and in the presence of detergent product. One or two subsequent cold rinses serve to remove from the machine most of the soil freed during the main wash, as well as any residues of detergent. Finally, a heated final rinse is used to speed drying of the load and to assure good final appearance of glasses and cutlery. Normally, rinse cycle compositions are dispensed automatically into this final hot rinse cycle, after the maximum water temperature has been achieved. The number and duration of cycles will normally vary with the washing machine manufacturer, and, indeed, each machine typically has several wash programs from which the operator may choose. All wash programs, however, will consist, at least, of a main wash and two rinse cycles.

It is a further object of this invention to specify the optimum dosing profile in order to achieve the most effective use of the antiscalant component of the rinse cycle composition. In terms of the above model wash program, it has surprisingly been discovered that the best antiscalant action can be obtained from the least antiscalant if this additive is present (at comparable levels) into each of the penultimate and the final rinse cycle. This concentration profile is superior to addition of all of the rinse cycle additive to either of the penultimate or the final rinse cycle. (The recommended dosing profile is likewise found to be considerably superior to dosing into the wash or pre-wash cycles since, in this case, the rinse cycle composition is discharged from the washing machine at the end of the respective cycle and is no longer present at the commencement of the rinse cycles.)

For the purposes of this invention, the level of the copolymer antiscalant component of the rinse cycle composition should be about 0.1 ppm to 120 ppm of the cycle liquor media in each of the penultimate and final rinse cycles. Preferably, the antiscalant should be present at 0.5 ppm to about 115 ppm in each of the final two rinse cycles. Most preferably, the dosage of the copolymer antiscalant component of the rinse cycle composition should be from about 10 ppm to about 100 ppm in each of the penultimate and final rinse cycles. Further, the weight ratio of the level of dosed antiscalant in the penultimate rinse cycle to that in the final rinse cycle should be from about 1:10 to about 10:1, preferably from about 1:5 to about 5:1, optimally from about 1:2 to about 2:1.

The preferred concentration profile of the rinse cycle composition can be achieved in a variety of ways. Without intending to be restrictive, possible approaches include using the automatic rinse aid dispenser in the washing machine to dispense (equal dosages of) a liquid rinse aid into each of the penultimate and final rinse. A second way of achieving the dosage profile is to form the rinse aid composition, either alone or optionally with other ingredients, into a solid form such as a block or tablet. Solid forms could be placed within the washing machine at any time, provided that it was in place prior to the penultimate rinse cycle. The rinse aid composition would then dissolve from the solid form during each of the penultimate and final rinse cycles to give the desired concentration profile. If the solid form were added at the commencement of the dishwasher program, the additive might well also be dissolved into the pre-wash and wash cycles. The desired profile can still be achieved in this case, provided that enough of the solid form was left to deliver into the rinse cycles. Such a delivery mechanism would thus include slowly dissolving blocks and tablets designed to last for several wash programs as well as blocks, tablets and granules designed to dissolve slowly or in a controlled fashion.

Another way of delivering the appropriate level of anti-scaling polymer is to incorporate the anti-scaling polymer into a separate region of a tablet that will preferentially dissolve in the low pH rinse. Thus, any method that releases ingredients via preferential dissolution in low pH or low ionic strength, will not release the anti-scaling agent during the main wash, with its relatively high pH and ionic strength, but will do so in the final rinses where the pH and ionic strength are lower.

An alternative way of delivering the anti-scaling polymer at the appropriate times of the wash cycle is to include it in a separate region of the tablet that melts at temperatures that approximate those found in the final rinse or towards the end of the main wash. Thus, since the temperature of the rinse cycle (about 70° C.) is typically higher than that of even the highest temperature wash (about 50-60° C.), some release of anti-scaling agent will occur during the main wash and be carried over into the penultimate rinse, and the remainder will be released into the final rinse, triggered by the higher wash temperatures.

A preferred way of delivering the appropriate level of anti-scaling agent into the penultimate rinse and into the final rinse is to deliver the anti-scalant via two mechanisms. Thus, a level of anti-scalant included in the main wash detergent is such that a sufficient amount is carried over into the penultimate rinse. However, the additional dilution that occurs from the penultimate rinse to the final rinse will be such that an insufficient level of anti-scaling agent will be carried over into the final rinse. In order to deliver the anti-scaling polymer into the final rinse, it is incorporated into a separate region of the tablet that allows release of ingredients into the final rinse, but not into the main wash. Such a trigger may be a material, such as a wax, that has a melting point above that of traditional main washes, but below that of the rinse. Similarly, a system that can release ingredients at high temperature, low pH and low ionic strength, but not at high temperature, high pH and high ionic strength, or low temperature, low pH and low ionic strength, will preferentially release anti-scaling agent into the final hot rinse, but not in the hot main wash nor in the cold penultimate rinse.

It will be appreciated by those skilled in the art that the level of dosed antiscalant polymer component of the rinse cycle composition, depending on the means of delivery, can vary during the course of any designated cycle. Thus, when the antiscalant is injected as a liquid rinse aid, its level rapidly rises from zero before injection to a constant plateau value. When the antiscalant component dissolves from a solid form, its level in solution will typically increase during the course of the cycle, unless the solid form dissolves completely. In this latter case, the level of antiscalant will reach a plateau value at the time of complete dissolution and remain unchanged until the end of the cycle. The levels of antiscalant referred to above will be defined, for the purposes of this invention, as those measured in the rinse cycle liquors at the end of the respective cycle. The level can be ascertained by removing a sample of the rinse cycle liquor from the interior of the washing machine or from the water discharged by the machine at the end of the respective cycle. The sample can then be analyzed for the antiscalant by any suitable analytical means, including UV/visible spectroscopy, atomic absorption or emission spectroscopy, nuclear magnetic resonance spectroscopy, liquid chromatography, or an appropriate gravimetric or volumetric technique.

The rinse cycle composition containing the scale inhibiting polymer can take a variety of physical forms, consistent with the aforementioned dosage profile requirements. Some examples of the possible physical forms are described in detail in the following section.

### Traditional Rinse Aid

When the polymer is incorporated into a traditional liquid rinse aid composition, it is to be present in an effective amount, preferably from about 0.01% to about 33% by wt., more preferably from about 0.075 to about 20% by wt., most preferably from about 0.15% to about 15% by wt. These amounts correspond to a polymer level of about 0.1 ppm to about 200 ppm, preferably from about 0.5 ppm to about 120 ppm, most preferably from about 1 ppm to about 100 ppm in the rinse liquor if the rinse aid is used at a normal dosage level of 3 ml/5 liter rinse water.

Another objective of the invention is to provide a process for warewashing in a dishwashing machine whereby in each of the penultimate and final rinse steps there is present in the rinse water a scale inhibiting polymer defined within the scope of this invention at an amount such that the rinse liquors contain the defined polymers at a concentration of from about 0.1 ppm to about 200 ppm, preferably, from about 1 ppm to about 100 ppm. Further, the ratio of the level of dosed antiscalant in the penultimate rinse cycle to that in the final rinse cycle should be from about 0.1 to about 10, preferably from about 0.2 to about 5. Most preferably, the ratio of the level of the dosed antiscalant component of the rinse cycle composition in the penultimate rinse cycle to that in the final rinse cycle should be from about 0.2 to about 2.0.

### pH of the Compositions

The pH of compositions of this invention as a 1% solution in distilled water at 20° C. may range from about 0.5 to about 12. In a highly preferred aspect of the invention, the compositions have a pH of less than 7, preferably from about 0.5 to about 6.5, most preferably from about 1.0 to about 5.0.

The pH of the compositions may be adjusted by the use of various pH adjusting agents. Preferred acidification agents include inorganic and organic acids including, for example, carboxylic acids, such as citric and succinic acids, polycarboxylic acids, such as polyacrylic acid, and also acetic acid, boric acid, malonic acid, adipic acid, fumaric acid, lactic acid, glycolic acid, tartaric acid, tartronic acid, maloic acid, their derivatives and any mixtures of the foregoing. The most preferred acidification acid is citric acid which has the advantage of providing builder capacity to the rinse solution. However, it should be emphasized that, although addition of acidification agent will enhance performance, it is not essential to the invention. Thus, anti-scaling agents alone can deliver an acceptable benefit.

### Solid Form—Tablet

When the polymer, as a component of a rinse cycle composition, is incorporated into a solid tablet, it is to be present in an effective amount, preferably from about 0.1% to about 80% by weight of the solid tablet, more preferably from about 0.2% to about 75%, most preferably from about 0.5 to about 70% of the solid tablet.

In a preferred embodiment of the invention, the polymer, as a component of a rinse cycle composition, is combined with a co-tableting agent as a core tablet. These core tablets can then, if desired, be tableted within a main tablet consisting of a main wash cycle detergent composition. Such a composite is usually referred to in the art as a compression coated tablet. The co-tableting agent should preferably be a component which assists in the tableting process and improves the physical and chemical integrity of the tablet. It is highly desirable that the compacted form possess adequate hardness and strength in order to meet safety requirements and to resist damage upon packing, transport or storage. Most critically, the co-tableting agent must also act to control the dissolution of the rinse cycle composition and specifically the antiscalant polymer so that the polymer is dosed into the penultimate and final rinse cycles in the manner specified above. Suitable co-tableting agents can include nonionic surfactants, waxes, water soluble polymers, and clays. An alternative approach is to employ a three (or more) layer tablet in which the rinse cycle component and any co-tableting agents compose the central tablet layer and with the main wash cycle detergent composition constituting the outer layers. Exemplary co-tableting agents are described in detail below.

### Nonionic Surfactant

Nonionic surfactants are optimal but useful components of compositions according to the present invention. Essentially any nonionic surfactant which can form a viscous phase when contacted with water can be included in the composition as a co-tableting aid. Exemplary, non-limiting classes of useful nonionic surfactant are listed below.

Nonionic condensates of alkyl phenols such as the polyoxyethylene, polyoxypropylene, and polyoxybutylene condensates of alkyl phenols are suitable for use herein. Particularly preferred are the polyethylene oxide condensation products containing a linear alkyl group containing from 8 to 18 carbon atoms with from about 8 to about 50 moles of ethylene oxide per mole of alkyl phenol. Certain of the polyethylene oxide alkylphenol surfactants designated ‘Igepal’ by Rhône-Poulenc, Inc. are suitable as co-tableting components of the invention. Examples of such preferred ethoxylated alkyl phenols are Igepal CO-850, CO-880 and CO-970.

Nonionic ethoxylated alcohols such as the alkyl ethoxylate condensation products of C₆-C₂₂ aliphatic alcohols with from about 1 to about 25 moles of ethylene oxide are suitable for use herein. Particularly preferred are the condensation products of linear alcohols having an alkyl group containing from 8 to 16 carbon atoms with from about 6 to about 13 moles of ethylene oxide per mole of alcohol. Certain of the ethoxylated alcohol surfactants designated ‘Neodol’ by the Shell Chemical Company are suitable as co-tableting components of the invention. Examples of preferred ethoxylated alcohols are Neodol 25-9, 25-12, and 45-13.

Nonionic EO/PO condensates with propylene glycol such as the condensation products of ethylene oxide with a hydrophobic base formed by the condensation of propylene oxide with propylene glycol are suitable for use herein. These condensates comprise polyoxyethylene, polyoxypropylene block copolymers. The hydrophobic portion of these compounds comprises the polyoxypropylene block and preferably has a molecular weight of from about 1500 to about 4000 and exhibits water insolubility. The hydrophilic portion of these compounds comprises the polyoxyethylene blocks and typically constitutes from about 30% to 90% of the total block copolymer molecular weight. The polyoxyethylene blocks are sandwiched around the hydrophobic portion so as to confer overall water solubility. Such preferred polyoxyethylene-polyoxypropylene block copolymers of high hydrophilic content are usually present in solid form at room temperature, making possible their incorporation into tablets. Examples of compounds of this type include certain of the commercially-available ‘Pluronic’ surfactant series, marketed by BASF.

Nonionic EO condensation products with propylene oxide/ethylene diamine adducts are also suitable for use herein. These condensates comprise polyoxyethylene, polyoxypropylene block copolymers. The hydrophobic portion of these compounds comprises the polyoxypropylene block and preferably has a molecular weight of from about 1500 to about 7000 and exhibits water insolubility. The hydrophilic portion of these compounds comprises the polyoxyethylene blocks and typically constitutes from about 30% to 90% of the total block copolymer molecular weight. The polyoxyethylene blocks are sandwiched around the hydrophobic portion so as to confer over all water solubility. Examples of compounds of this type include certain of the commercially-available ‘Tetronic’ surfactant series such as Tetronic 1307, marketed by BASF.

The level of surfactant used as a co-tableting agent should be from about 5% to about 70% by weight, based on the total weight of core tablet or middle layer (for a three layer tablet). Preferably, the level of surfactant should be from about 6% to about 50%, most preferably, the level should be from about 10% to about 30%.

### Waxes

Waxes are another optional but useful component of compositions according to the present invention. Waxes are hydrocarbons which are typically derived from petroleum. Three types of wax may be distinguished (see Kirk-Othmer, Encyclopedia of Chemical Technology, 3rd Edition, Wiley, Vol 24, pages 466-481, ISBN 0-471-02077-X): paraffin wax, microcrystalline wax, and semi-microcrystalline wax. For application to the present invention, suitable waxes will be those with a melting point approximately equal to or greater than the temperature in the main wash cycle of the dishwasher. This temperature is in the range of 50-65° C. for current domestic dishwashers in Europe.

Paraffin wax consists principally of normal alkanes. It is composed of 40-90% normal paraffins, the remainder being C₁₈-C₃₆ isoalkanes and cycloalkanes. The melting point of the wax determines the actual grade and varies between 46° C. and 71° C. The weight average molecular weight of these waxes is between about 350 and 420. A suitable paraffin wax for use in the present invention is BDH Pastillated Paraffin Wax, having a melting point of 51-55° C. A particularly preferred paraffin wax is IW1240, supplied by IGI with a melting point of 57° C.

Semi-microcrystalline and microcrystalline waxes contain substantial proportions of hydrocarbons other than normal alkanes. Microcrystalline waxes typically have a melting point between 60° C. and 93° C. Average molecular weights range between about 600 and 800.

A suitable microcrystalline wax for use in the present invention is MMP, supplied by Shell. Other waxes suitable for use in the present invention include: beeswax, vegetable wax (including candelilla, carnuba, Japan wax, ouricury wax, douglas-fir bark wax, rice-bran wax, jojoba, castor wax, bayberry wax), mineral waxes including Montan wax and peat waxes, synthetic waxes including polyethylene wax, Fischer-Tropsch waxes (polymethylene waxes), chemically modified hydrocarbon waxes, and substituted amide waxes.

The amount of paraffin wax used as a co-tableting agent may range from about 10% to about 70% by weight, based on the total weight of core tablet or middle layer (for a three layer tablet).

In addition to the above described co-tableting agents, the list of such agents pertinent to the present invention also includes the class of water soluble polymers and swelling clays. The formulator will recognize that such materials will generally be used judiciously and in limited quantities so as to avoid any tendency to produce spots or films on glassware or to compromise the bleaching action of the compositions.

Water soluble polymers which form a slowly dissolving gel upon contacting water will be useful in the instant invention. Such polymers include natural gums such as xanthan gum, locust bean gum, and guar gum. Also of use in the present invention are the semi-synthetic cellulosic thickeners including hydroxyethyl and hydroxymethyl cellulose, available from Dow Chemical as ‘Ethocel’ and ‘Methocel’, respectively.

A distinct class of water soluble polymer useful in the context of this invention are the hydroxylic polymers whose anhydrous forms have a glass transition temperature, T_{g}, in the range of 0-100° C., more preferably in the range 25-75° C., most preferably in the range 35-60° C. Polymers belonging to this class include polyvinyl alcohol, polyacrylamide, and polyacrylic acid.

Essentially any clay can be used for a co-tableting agent, as long as it will swell in an aqueous environment and develop thixotropic properties. Possible swelling clays include those of the smectite type including montmorillonite (bentonite), hectorite, nontronite, and saponite. Additional examples of potentially useful clays include attapulgite, illite and kaolinite. Commercially available montmorillonite clays include Thixogel and Gelwhite from Georgia Kaolin Company, and Eccagum from Luthern Clay Products. Additionally, colloidal or finely divided silicas, and aluminum silicate could be used as co-tableting agents.

The amount of polymer or clay used as a co-tableting agent may range from about 5% to about 60% by weight, based on the total weight of core tablet or middle layer (for a three layer tablet). Preferably, the level of polymer or surfactant should be from about 6% to about 50%, most preferably, the level may be from about 10% to about 40%.

Traditional co-tableting agents can also be included with the co-tableting agents described above and with the antiscalant copolymer in order to obtain a suitable tablet. Co-tableting agents include binders, which increase the cohesiveness of the powder fill to be tableted. Examples of such materials include natural (acacia) and cellulose gums, lactose, dextrose, mannitol, starches, gelatin, and polyvinylprrolidone. Co-tableting agents also include excipients such as lactose or microcrystalline cellulose, and lubricants, which reduce friction and make possible high speed processing. Examples of lubricants include calcium or magnesium stearate, talc, and sodium or magnesium lauryl sulfate.

### Solid Form—Block

When the polymer, as a component of a rinse cycle composition, is incorporated into a solid block, it is to be present in an effective amount, preferably from about 0.1% to about 50% by weight of the solid block, more preferably from about 0.2% to about 30%, most preferably from about 0.5 to about 20% of the solid block. The solid block may be manufactured as a cast melt or as a compacted solid. When manufactured as a cast melt, the balance of the composition of the solid form would consist of a solidification aid while, when manufactured as a compacted solid, the balance of the composition of the solid form would consist of a co-tableting agent similar to those used in the tablet form option. In both cases, optional ingredients could be incorporated as well.

The cast melt blocks would comprise a suitable solidification aid whose purpose is to maintain the block in solid form throughout the machine dishwashing cycle. The purpose of said solidification aid is further, and most importantly, to control the dissolution of the incorporated rinse cycle composition so that the copolymer component is delivered into the penultimate and final rinse cycles in the manner specified above. A preferred solidification aid comprises an organic binder such as polyethylene glycol (PEG) as exemplified by the Carbowax series supplied by Union Carbide; by the Polyox series supplied by Amerchol; and by the Pluracol series from BASF. The average molecular weight of polyethylene glycols suitable for this invention may range from about 200 to about 200,000, preferably from about 1000 to about 100,000, most preferably from about 4600 to about 20,000. The corresponding melting points of the suitable polyethylene glycols range from about −20 to about 70° C., preferably from about 30 to about 65° C., most preferably from about 55 to about 65° C.

Alternative organic binders suitable for the present invention include methoxypolyethylene glycols as supplied by Union Carbide, polyoxyethylene sorbitan fatty acid esters such as supplied by ICI under the trade name Tween, and polyoxyethylene fatty acid esters such as supplied by ICI under the trade name Myrj. Polyoxyethylene sorbitan fatty acid esters of lauric, palmitic, stearic and oleic acid are preferred when used as the monoester. Particularly preferred are those esters containing at least 20 moles ethylene oxide adducts. Highly preferred are the monostearate esters because of their high melting point. Particular examples of suitable materials include Tween 60 and 60K (ICI), Emsorb 2728 (Henkel), and Glycosperse S-20 (Lonza). Polyoxyethylene fatty acid esters of stearic acid are preferred. Particularly preferred are those esters containing 100 or more moles ethylene oxide adducts because of their high melting point. Particular examples of suitable materials include Myrj 59 and 59L (ICI), Kessco PEG 6000 (Stepan), and Aldo MSA (Lonza).

Other organic binding agents suitable for inclusion in the present invention include the nonionic surfactants described above as co-tableting aids and certain water soluble polymers such as polyvinylprrylidone.

The compacted solid form blocks may be manufactured using any suitable compacting process, such as tableting, briquetting, or extrusion. Blocks made by tableting may be prepared using either a single punch or a standard rotary tableting press using compression forces of from 5 to 25 KN/cm², more preferably from 5 to 15 KN/cm², so that the compacted solid has a minimum hardness of 170 to 250 N, preferably from 190 to 280 N.

### Main Wash Tablet with Controlled Release into Final Rinse

In a particularly preferred embodiment of the present invention, the polymer is present in two distinct physical forms; as part of a solid form tablet comprising an intimate mixture with the main wash cycle detergent composition and as either a distinct layer/subsection of the solid form tablet or as a second solid form tablet or block. As a component of a solid form tablet comprising an intimate mixture with the main wash cycle detergent, the antiscalant polymer is present in an effective amount, preferably from about 0.1% to about 80% by weight of the solid tablet, more preferably from about 0.2% to about 75%, most preferably from about 0.5% to about 70% of the solid tablet. The balance of the solid tablet will consist of co-tableting agents, at the levels described above, as well as main wash detergent ingredients, preferably selected from surfactants, builders, heavy metal ion sequestrants, enzymes, buffering systems, oxygen bleaching systems, antiscalants, corrosion inhibitors, antifoams, lime soap dispersant compounds, solvents, and hydrotropes, as described in detail below.

As a distinct layer/subsection of a solid form tablet, the antiscalant polymer is present in an effective amount, preferably from about 0.1% to about 80%, more preferably from about 0.2% to about 75%, most preferably from about 0.5% to 70% by weight of the solid tablet of the second solid form. The polymer as a component of a rinse aid cycle composition, is combined with a co-tableting agent to form a distinct layer or subsection of the solid form tablet. As non-limiting examples, the distinct layer or subsection may consist of compression coated tablets or of a central layer within a three (or more) layer tablet—with the main wash cycle detergent comprising the outer layers. Other examples of distinct subsections within a solid form tablet can be envisioned by those skilled in the art, as long as the subsections, combined with the remainder of the solid tablet, allow for the preferred rinse cycle composition dosage into both the penultimate and the final rinse cycles. The desired dosage pattern can be achieved via controlled release of the antiscalant polymer from the distinct subsection, as discussed previously, using co-tableting agents which slow dissolution (nonionic surfactants) or which delay dissolution until the final rinse (wax or water soluble polymers).

As a component of a second solid form tablet or bloci, the antiscalant polymer is present in an effective amount, preferably from about 0.1% to about 80% more preferably from about 0.2% to about 75%, most preferably from about 0.5% to 70% by weight of the solid tablet of the second solid form. The remainder of the tablet or block may consist of co-tableting aids and, optionally, of certain of the main wash detergent ingredients. The co-tableting agents would be those for use in controlling the dissolution of the rinse cycle composition so that, in combination with the main wash tablet, the anti-scalent polymer is dosed into both of the penultimate and final rinse cycles. Co-tableting agents consistent with this application include nonionic surfactants, waxes, water soluble polymers, and clays, as described above.

### Optional Ingredients

In addition to the essential ingredients described herein above, the compositions of the present invention may be formulated as rinse aids or as detergent compositions comprising conventional ingredients, preferably selected from surfactants, builders, heavy metal ion sequestrants, enzymes, buffering systems, oxygen bleaching systems, antiscalants, corrosion inhibitors, antifoams, lime soap dispersant compounds, solvents, and hydrotropes.

### Surfactant System

A surfactant system comprising a surfactant selected from nonionic, anionic, cationic, ampholytic and zwitterionic surfactants and mixtures thereof is preferably present in the composition.

The surfactant system most preferably comprises low foaming nonionic surfactant, selected for its wetting ability, preferably selected from ethoxylated and/or propoxylated nonionic surfactants, more preferably selected from nonionic ethoxylated/propoxylated fatty alcohol surfactants.

The surfactant system is typically present at a level of from about 0.1% to about 40% by weight, more preferably about 0.2% to about 30% by weight, most preferably from about 0.5% to about 20% by weight of the compositions.

### Builder System

A highly preferred component of the rinse cycle compositions of the present invention is a detergent builder system which is preferably present at a level of from 0% to about 60% by weight, more preferably from about 1% to about 30% by weight, most preferably from about 2% to about 20% weight of the composition.

When the rinse cycle composition is combined with the main wash cycle detergent, as in a solid tablet form, the builder component can be chosen from the alkali metal, ammonium and alkanolammonium salts of polyphosphates (exemplified by the tripolyphosphates, pyrophosphates, and glassy polymeric meta-phosphates). Specific examples of phosphate builders are the alkali metal tripolyphosphates, sodium, potassium and ammonium pyrophosphate, sodium and potassium orthophosphate, sodium polymeta/phosphate in which the degree of polymerization ranges from about 6 to 21, and salts of phytic acid.

More generally the detergent builder component of the rinse cycle composition is preferably water-soluble, and can, for example, contain builder compounds selected from monomeric polycarboxylates and their acid forms or homo or copolymeric polycarboxylic acids and their salts in which the polycarboxylic acid comprises at least two carboxylic radicals separated from each other by not more than two carbon atoms.

Suitable water-soluble monomeric or oligomeric carboxylate builders can be selected from a wide range of compounds but such compounds preferably have a first carboxyl logarithmic acidity/constant (pK₁) of less than 9, preferably of between 2 and 8.5, more preferably of between 2.5 and 7.5.

### Optional Builders

When the rinse cycle composition is formulated as a liquid rinse aid or as a solid block designed to be left in the dishwasher for multiple runs, it will be appreciated by those skilled in the art that the alkali metal, ammonium and alkanolammonium salts of polyphosphates described above will, if present at underbuilt levels in the rinse water, exacerbate any scaling problems and therefore, for this reason, be less desirable as builders.

A similar caveat applies to the selected builders described in this optional builder section. Other water-soluble detergent builders include, but are not limited to, silicates, carbonates (including bicarbonates and sesquicarbonates), sulfates, borate builders, as well as builders containing borate-forming materials that can produce borate under detergent storage or wash conditions can also be used.

Suitable silicates include the water soluble sodium silicates with an SiO₂: Na₂O ratio of from 1.0 to 2.8, with ratios of from 1.6 to 2.4 being preferred, and 2.0 ratio being most preferred. The silicates may be in the form of either the anhydrous salt or a hydrated salt.

The compositions of the invention may also include less water soluble builders although preferably their levels of incorporation are minimized. Examples of such less water soluble builders include the crystalline layered silicates, and the largely water insoluble sodium aluminosilicates.

### Heavy Metal Ion Sequestrants

The rinse cycle compositions herein may also optionally contain transition metal chelating agents (sequestrants). These chelating agents may also have calcium and magnesium chelation capacity, but preferentially they bind heavy metal ions such as iron, manganese and copper.

Heavy metal ion sequestrants are preferably present at a level of from 0.005% to 20%, more preferably from 0.1% to 10%, most preferably from 0.2% to 5% by weight of the composition.

Heavy metal ion sequestrants, which are acidic in nature, having for example carboxylic acid or phosphonic acid functionalities, may be present either in their acid form or as a complex/salt with a suitable counter cation such as an alkali or alkaline metal ion, ammonium, or substituted ammonium ion, or any mixtures thereof. Preferably any salts/complexes are water soluble. The molar ratio of said-counter cation to the heavy metal ion sequestrant is preferably at least 1:1.

### Enzymes

Enzymes capable of facilitating the removal of soils from a substrate may also be present in a combined amount of up to about 10% by weight of active enzyme. Such enzymes include proteases, amylases, lipases, esterases, cellulases, pectinases, lactases and peroxidases as conventionally incorporated into detergent compositions.

Preferred commercially available protease enzymes include those sold under the tradenames Alcalase, Savinase and Esperase from Novo Industries A/S (Denmark); and those sold by Genencor International under the tradename Purafect OxP. Preferred commercially available amylases include those α-amylases sold under the tradenames Termamyl and Duramyl from Novo Industries and those sold by Genencor International under the tradename Purafect OxAm. A preferred lipase is commercially available from Novo Industries under the trade name Lipolase.

### Buffering System

When the rinse cycle composition is combined with the main wash cycle detergent, as in a solid tablet form, a buffering system may be present in order to deliver a pH of about 6 to about 11 in the wash water. Materials which may be selected for the buffering system include water-soluble alkali metal carbonates, bicarbonates, sesquicarbonates, borates, silicates, layered silicates such as SKS-6 ex Hoechst, metasilicates, phytic acid, citric acid, borate and crystalline and amorphous aluminosilicates and mixtures thereof. Preferred examples include sodium and potassium carbonate, sodium and potassium bicarbonates, borates and silicates, including layered silicates.

### Oxygen Bleaching Systems

The present invention may optionally contain an oxygen bleach source chosen from the following:

### Peroxy Bleaching Agents

The oxygen bleaching agents of the compositions include organic peroxy acids and diacylperoxides. Typical monoperoxy acids useful herein include alkyl peroxy acids and aryl peroxy acids such as magnesium monoperoxyphthalate, epsilon-phthalimido-peroxyhexanoic acid and o-carboxybenzamido peroxyhexanoic acid, N-nonylamidoperadipic acid and N-nonylamidopersuccinic acid.

Typical diperoxy acids useful herein include alkyl diperoxy acids and aryl diperoxy acids, such as N,N¹-terephthaloyl-di(6-aminopercaproic acid). A typical diacylperoxide useful herein includes dibenzoyiperoxide.

Inorganic peroxygen compounds are also suitable for the present invention. Examples of these are salts of monopersulfate, perborate monohydrate, perborate tetrahydrate, and percarbonate.

The organic peroxy acid is present in the composition in an amount such that the level of organic peroxy acid in the wash solution is about 1 ppm to about 300 ppm AvOx, preferably about 2 ppm to about 200 ppm AvOx.

The oxygen bleaching agent may be incorporated directly into the formulation or may be encapsulated by any number of encapsulation techniques.

A preferred encapsulation method is described in U.S. Pat. No. 5,200,236 issued to Lang et al., herein incorporated by reference. In the patented method, the bleaching agent is encapsulated as a core in a paraffin wax material having a melting point from about 40° C. to 50° C. The wax coating has a thickness of from 100 to 1500 microns.

### Bleach Precursors

Typical examples of precursors are polyacylated alkylene diamines, such as N,N,N′,N′-tetraacetylethylene diamine (TAED) and N,N,N′,N′-tetraacetylmethylene diamine (TAMD); acylated glycolurils, such as tetraacetylglycoluril (TAGU); triacetylcyanurate, sodium sulfophenyl ethyl carbonic acid ester, sodium acetyloxybenene sulfonate (SABS), sodium nonanoyloxy benzene sulfonate (SNOBS) and choline sulfophenyl carbonate.

Preferred peroxygen bleach precursors are sodium p-benzoyloxybenzene sulfonate, N,N,N′,N′-tetraacetylethylene diamine, sodium nonanoyloxybenzene sulfonate and choline sulfophenyl carbonate.

The peroxygen bleach precursors are present in the composition in an amount from about 1 to about 20 weight percent, preferably from about 1 to about 15 wt. %, most preferably from about 2 to about 15 wt. %. To deliver a functional peroxygen bleach from a precursor, a source of hydrogen peroxide is required. The hydrogen peroxide source is preferably a compound that delivers hydrogen peroxide on dissolution. Preferred sources of hydrogen peroxide are sodium perborate, either as the mono- or tetrahydrate and sodium percarbonate. The source of hydrogen peroxide, when included in these compositions is present at a level of about 1% to about 40% by weight, preferably from about 2% to about 30% by weight, most preferably from about 4% to about 25% by weight.

### Bleach Catalyst

An effective amount of a bleach catalyst can also be present in the invention. A number of organic catalysts are available such as the sulfonimines as described in U.S. Pat. Nos. 5,041,232; 5,047,163 and 5,463,115.

Transition metal bleach catalysts are also useful, especially those based on manganese, iron, cobalt, titanium, molybdenum, nickel, chromium, copper, ruthenium, tungsten and mixtures thereof. These include simple water-soluble salts such as those of iron, manganese and cobalt as well as catalysts containing complex ligands.

Suitable examples of manganese catalysts containing organic ligands are Mn^{IV}₂(u—O)₂(1,4,7-trimethyl-1,4,7-triazacyclononane)₂(PF₆)₂, Mn^{III}₂(u—O)₁(u—OAc)₂(1,4,7-trimethyl-1,4,7-triazacyclononane)₂(CIO₄)₂, Mn^{IV}₄(u—O)₆(1,4,7-triazacyclononane)₄ (CIO₄)₄, Mn^{III}Mn^{IV}₄(u—O)₁(u—OAc)₂(1,4,7-trimethyl-1,4,7-triazacyclononane)₂(CIO₄)₃, Mn^{IV}(1,4,7-trimethyl-1,4,7-triazacyclononane)-(OCH₃)₃(PF₆), and mixtures thereof.

Useful catalysts based on cobalt are of the type [CoₙLₘXₚ]^{z}Y_{z}, where L is an organic ligand molecule containing more than one heteroatom selected from N, P, O and S; X is a coordinating species; n is preferably 1 or 2; m is preferably 1 to 5; p is preferably 0 to 4 and Y is a counterion. One example of such a catalyst is N,N′-Bis(salicylidene)ethylenediaminecobalt (II).

When present, the bleach catalyst is typically incorporated at a level of about 0.0001 to about 10% by wt., preferably about 0.001 to about 5% by weight.

### Additional Anti-Scalants

Additional antiscalants may be incorporated into the present invention in order to control scale formation on dishes and machine parts which arises from the precipitation of either alkaline earth metal carbonates or silicates. Calcium carbonate precipitation is generally the most significant problem. To reduce this problem, ingredients can be incorporated into the composition, including polyacrylates of molecular weight from 1,000 to 400,000 examples of which are supplied by Rohm & Haas, BASF and Alco Corp. and polymers based on acrylic acid combined with other moieties. These include acrylic acid combined with maleic acid, such as Sokalan CP5 and CP7 supplied by BASF or Acusol 479N supplied by Rohm & Haas; with methacrylic acid such as Colloid 226/35 supplied by Rhone-Poulenc; with phosphonate such as Casi 773 supplied by Buckman Laboratories; with maleic acid and vinyl acetate such as polymers supplied by Hüls; polymaleates such as Belclene 200 supplied by FMC; polymethacrylates such as Tamol 850 from Rohm & Haas; polyaspartates; ethylenediamine disuccinate; organo polyphosphonic acids and their salts such as the sodium salts of aminotri(methylenephosphonic acid) and ethane 1-hydroxy-1,1-diphosphonic acid. The anti-scalant, if present, is included in the composition from about 0.05% to about 10% by weight, preferably from 0.1% to about 5% by weight, most preferably from about 0.2% to about 5% by weight.

### Corrosion Inhibitors

The composition my optionally contain corrosion inhibitors to reduce the tarnishing of silver flatware. Such inhibitors include benzotriazole and other members of the azole family.

### Antifoams

The compositions of the present invention, when formulated for use in machine dishwashing compositions, preferably comprise an antifoam system. Suitable antifoam systems for use herein may comprise essentially any known antifoam compound, including, for example, silicone antifoams, silicone oil, mono- and distearyl acid phosphates, mineral oil, and 2-alkyl and alcanol antifoam compounds. Even if the machine dishwashing composition contains only de-foaming surfactants, the antifoam assists to minimize foam which food soils can generate. The compositions may include 0.02 to 2% by weight of antifoam, preferably, 0.05 to 1.0%.

### Lime Soap Dispersant Compound

The compositions of the invention may contain a lime soap dispersant compound, which has a lime soap dispersing power (LSDP), as defined hereinafter, of no more than 8, preferably no more than 7, most preferably no more than 6. The lime soap dispersant compound is preferably present at a level of from 0.1% to 40% by weight, more preferably 1% to 20% by weight, most preferably from 2% to 10% by weight of the compositions.

Surfactants having good lime soap dispersant capability will include certain amine oxides, betaines, sulfobetaines, alkyl ethoxysulfates and ethoxylated alcohols.

Exemplary surfactants having a LSDP of no more than 8 for use in accord with the invention include C₁₆-C₁₈ dimethyl amine oxide, C₁₂-C₁₈ alkyl ethoxysulfates with an average degree of ethoxylation of from 1-5, particularly C₁₂-C₁₅ alkyl ethoxysulfate surfactants with a degree of ethoxylation of about 3 (LSDP=4) and the C₁₃-C₁₅ ethoxylated alcohols with an average degree of ethoxylation of either 12 (LSDP =6) or 30, sold under the trade names Lutensol A012 and Lutensol A030 respectively, by BASF GmbH.

### Solvent

The compositions of the invention may contain organic solvents, particularly when formulated as liquids or gels. The compositions in accord with the invention preferably contain a solvent system present at levels of from about 1% to about 30% by weight, preferably from about 3% to 25% by weight, more preferably form about 5% to about 20% by weight of the composition. The solvent system may be a mono or mixed solvent system. Preferably, at least the major component of the solvent system is of low volatility.

Suitable organic solvent for use herein has the general formula RO(CH₂C(Me)HO)ₙH, wherein R is an alkyl, alkenyl, or alkyl aryl group having from 1 to 8 carbon atoms, and n is an integer from 1 to 4. Preferably, R is an alkyl group containing 1 to 4 carbon atoms, and n is 1 or 2. Especially preferred R groups are n-butyl or isobutyl. Preferred solvents of this type are 1-n-butoxypropane-2-ol (n=1): and 1-(2-n-butoxy-1-methylethoxy)propane-2-ol (n=2), and mixtures thereof.

Other solvents useful herein include the water soluble CARBITOL solvents or water-soluble CELLOSOLVE solvents. Water-soluble CARBITOL solvents are compounds of the 2-(2 alkoxyethoxy)ethanol class wherein the alkoxy group is derived from ethyl, propyl or butyl; a preferred water-soluble carbitol is 2(2-butoxyethoxy) ethanol also known as butyl carbitol. Water-soluble CELLOSOLVE solvents are compounds of the 2-alkoxyethoxy ethanol class, with 2-butoxyethoxyethanol being preferred.

Other suitable solvents are benzyl alcohol, and diols such as 2-ethyl-1,3-hexanediol and 2,2,4-trimethyl-1,3-pentanediol.

The low molecular weight, water-soluble, liquid polyethylene glycols are also suitable solvents for use herein.

The alkane mono and diols, especially the C₁-C6 alkane mono and diols are suitable for use herein. C₁-C₄ monohydric alcohols (eg: ethanol, propanol, isopropanol, butanol and mixtures thereof) are preferred, with ethanol particularly preferred. The C₁-C₄ dihydric alcohols, including propylene glycol, are also preferred.

### Hydrotropes

A highly preferred component of the compositions of the invention is a hydrotrope. The hydrotrope is typically present at levels of from about 0.5% to about 20%, preferably from about 1% to about 10%, by weight.

Useful hydrotropes include sodium, potassium, and ammonium xylene sulfonates, sodium, potassium, and ammonium toluene sulfonate, sodium, potassium and ammonium cumene sulfonate, and mixtures thereof.

The term “vehicle” for purposes of this invention may refer to the sum of all other components forming the composition (e.g. the complete tablet or block other than the anti-scalant), or in other context can mean an encapsulating wax or other slow release protective chemical or device. Thus, ways of producing solid forms other than by tableting, such as by casting from the melt are encompassed herein. These ways may be combined with tableting to form a composite vehicle(s) for the preferred delivery of the antiscalant polymer into the penultimate and final rinse cycles.

### Machine Dishwashing Method

The rinse cycle compositions in accordance with the present invention may be used in essentially any conventional machine dishwashing method performed using a dishwasher machine, which may be selected from any of those commonly available on the market.

The machine dishwashing method typically comprises treating soiled articles, such as crockery, glassware, hollowware and cutlery, with an aqueous liquid having dissolved or dispersed therein an effective amount of detergent composition. By an effective amount of detergent composition it is generally meant from 8 g to 60 g of detergent composition per wash, dissolved or dispersed in a wash solution volume of from 3 to 10 liters, which are typical product dosages employed in conventional machine dishwashing methods. The wash temperature may be in the range 40° C. to 65° C. as commonly is employed in such processes. The rinse cycle composition, if embodied as a traditional liquid rinse aid, is typically employed at levels of from about 0.1 to about 5 g into each of the penultimate and final rinse cycles. When delivered via a controlled release mechanism from the main wash formulation, from a subsection of the main wash tablet, or from a separate solid form, the level of rinse cycle composition would preferably range from about 0.1 to about 5 g into each of the penultimate and final rinse cycles.

Except in the operating and comparative examples, or where otherwise explicitly indicated, all numbers in this description indicating amounts of material ought to be understood as modified by the word “about”.

The following examples will serve to distinguish this invention from the prior art and illustrate its embodiment more fully. Unless otherwise indicated, all parts, percentages and portions referred to are by weights.

### EXAMPLE 1

The machine dishwashing process comprises washing articles in a pre-wash cycle followed by the main wash cycle and rinsing them in two or more rinse cycles (pre-rinse and final rinse cycles). This example demonstrates the optimum delivery profile of a scale inhibitor, as a component of a rinse cycle composition, for preventing the formation of film on glassware during underbuilt machine dishwashing with hard water. It is also shown how this profile can be achieved using the present invention in the form of a liquid rinse aid.

Machine dishwashing experiments were carried out under the following conditions using a Bosch model 6082 dishwasher: 55° C.; Economy program, 400 ppm water hardness as CaCO₃. This wash program consists, sequentially, of a pre-wash cycle, a main wash cycle, a pre-rinse (penultimate rinse) cycle, and a final rinse cycle. Ten clean glass tumblers were uses as wash articles and loaded into the top rack of the dishwasher.

An STP-built tablet composition commercially available in Europe was used for the main wash cycle. The composition is shown in Table 1 below.

TABLE 1

| INGREDIENT | % WEIGHT |
|---|---|
| STP | 55.0 |
| Sodium Disilicate (80%) | 27.6 |
| Perborate Monohydrate | 9.0 |
| TAED (83%)* | 2.4 |
| Protease | 3.0 |
| Amylase | 1.8 |
| Nonionic Surfactant | 1.0 |
| Perfume | 0.15 |
| Benzotriazole | 0.05 |

*TAED = N,N,N′,N′-tetraacetylethylene diamine.

To determine the optimum delivery profile of a scale inhibitor in a dishwasher, two types of machine experiments were conducted. Firstly, at the beginning of one or two of the wash cycles, i.e. pre-wash, main wash, pre-rinse or final rinse, varying amounts of a scale inhibitor, Alcosperse® 240, were manually dosed into the machine (EXP# 2-10). Secondly, a minimum amount of the scale inhibitor, 0.15 g, was divided in various ways and added manually into the machine at the beginning of the pre-rinse cycle, or of the final rinse cycle, or of each of the rinse cycles (EXP# 11-15). The control run was conducted without adding a scale inhibitor (EXP# 1).

At the end of the whole wash program, the drinking glasses were visually graded by an expert panel for filming. Grade scales of from 0 to 5 were used to measure filming deposition, where a grade of 0 indicates no visible filming, a grade of 1 indicates a trace filming, a grade of 2 indicates a slight filming, a grade of 3 indicates a moderate filming, a grade of 4 indicates a heavy filming and a grade of 5 indicates coverage with a very heavy, opaque filming.

The following results for glass filming were obtained:

| | | | | | Glass |
|---|---|---|---|---|---|
| | Dose of Inhibitor, grams | | | | Filming |
| EXP | Pre-wash | Main Wash | Pre-rinse | Final Rinse | Score |
| 1 | 0 | 0 | 0 | 0 | 2.5 |
| 2 | 0.35 | 0 | 0 | 0 | 2.5 |
| 3 | 0 | 0.35 | 0 | 0 | 2.5 |
| 4 | 0.15 | 0.15 | 0 | 0 | 2.5 |
| 5 | 0.35 | 0.35 | 0 | 0 | 2.5 |
| 6 | 0 | 0 | 0 | 0.11 | 2.4 |
| 7 | 0 | 0 | 0 | 0.22 | 1.6 |
| 8 | 0 | 0 | 0 | 0.35 | 1.6 |
| 9 | 0 | 0 | 0.35 | 0 | 1.3 |
| 10 | 0 | 0 | 0.15 | 0 | 2.2 |
| 11 | 0 | 0 | 0.10 | 0.05 | 1.6 |
| 12 | 0 | 0 | 0.075 | 0.075 | 1.2 |
| 13 | 0 | 0 | 0.05 | 0.10 | 1.4 |
| 14 | 0 | 0 | 0 | 0.15 | 1.9 |
| 15 | 0 | 0.35 | 0 | 0 | 2.5 |
| 16 | 0 | 0.75 | 0 | 0 | 1.5 |
| 17 | 0 | 0.75* | 0 | 0 | 2.5 |
| 18 | 0 | 0.25 | 0 | 0.1 | 1.6 |

*Inhibitor prevented from carrying over from the main wash into the pre-rinse.

Experiments 6-9 show that adding an effective amount of inhibitor (0.35 g) into either of the pre-rinse or final rinse is effective in reducing scale formation. On the other hand, Experiments 2-5 show that comparable levels of inhibitor in the pre-wash and main wash cycles fail to control scale formation. Experiments 10-14 demonstrate that the optimum dosage profile for delivering the antiscalant is to split the dose between the pre-rinse cycle and the final rinse.

Experiments 2-14 suggest that another effective dosage profile would combine inhibitor, dosed in the main wash cycle and carried over to the pre-rinse, with inhibitor dosed in the final rinse. Although the total amount of scale inhibitor necessary may be higher than if dosed exclusively in the pre- and final rinses, the simplicity of achieving this dosage profile using the main wash could be a distinct advantage. Experiments 15 and 16 show that the glass filming score improves as the main wash dosage of anti-scalant polymer increases. In Experiment 17, the inhibitor carried over from the main wash is purged from the dishwashing machine by physically replacing most of the wash liquor, just prior to machine emptying, with otherwise identical wash liquor which did not contain inhibitor. Thus, there was essentially no carry-over of anti-scalant polymer from the main wash cycle to the pre-rinse, as opposed to the otherwise identical Experiment 16. The distinctly higher filming score seen in Experiment 17 is proof that inhibitor carried over from distinctly higher filming score seen in Experiment 17 is proof that inhibitor carried over from the main wash into the pre-rinse is an effective means of delivering anti-scalant polymer into the penultimate rinse cycle. Finally, as proof of the utility of this dosage profile, 0.25 g of inhibitor dosed into the main wash is combined with 0.1 g in the final rinse. The resulting film score, Experiment 18, is lower than would be expected from either dosage alone or than if all of the inhibitor were added into the main wash (Experiment 15).

### EXAMPLE 2

This example demonstrates a second possible route to achieving the optimum delivery profile of the scale inhibitor, as a component of a rinse cycle composition, described in Example 1. This example route employs a nonionic surfactant as a co-tableting agent for a core tablet containing the rinse cycle composition. This core tablet is included inside of a main tablet via compression coating.

0.35 g of Alcosperse® 240 and 0.15 g of a co-tableting agent were mixed and then pressed into a core tablet of 13 mm diameter using a Spex X-press (Model 3624B). This core tablet was included in the center of a 34 mm diameter main tablet, which has the composition shown in Table 1, prior to pressing and then the whole mixture pressed into a single tablet. The outer main tablet protects the core until the outer tablet dissolves, a situation which occurs around the end of the main wash. The core tablet will then be exposed at the beginning of the pre-rinse cycle. The desired co-tableting agents for the core tablet will be those materials which can control the release or dissolution of the core tablet so that said release can be sustained through the pre-rinse and into the final rinse. Certain gel-forming nonionic EO/PO block copolymers were used as the co-tableting agents because they form a gel phase once hydrated. This gel phase dissolves slowly and therefore sustains the release of ingredients with which it is intimately mixed. In this example, the beneficial delivery of inhibitor to the rinse water using nonionic surfactants as co-tableting agents is demonstrated.

Machine dishwashing experiments were carried out under the following conditions using a Bosch model 6082 dishwasher: 55° C.; Economy cycle, 400 ppm water hardness as CaCO₃. Ten clean glass tumblers were uses as wash articles, loaded into the top rack of the dishwasher.

At the end of the whole wash program, the drinking glasses were visually graded by an expert panel for filming. Grade scales of from 0 to 5 were used to measure filming deposition, where a grade of 0 indicates no visible filming, a grade of 1 indicates a trace filming, a grade of 2 indicates a slight filming, a grade of 3 indicates a moderate filming, a grade of 4 indicates a heavy filming and a grade of 5 indicates coverage with a very heavy, opaque filming.

The following results were obtained:

| Sample | Co-binder | Inhibitor* | Glass Filming Score |
|---|---|---|---|
| 1-control | N/A | None | 2.5 |
| 2 | 0.15 g Pluronic ® F1080 | 0.35 g | 1.4 |
| 3 | 0.15 g Pluronic ® F98 | 0.35 g | 1.6 |
| 4 | 0.15 g Tetronic ® 1307 | 0.35 g | 1.2 |
| 5 | 0.15 g Tetronic ® 1107 | 0.35 g | 2.2 |
| 6 | 0.15 g Pluronic ® F87 | 0.35 g | 2.2 |
| 7 | 0.15 g Tetronic ® 1307 | None | 2.5 |

*Inhibitor = Alcosperse ® 240

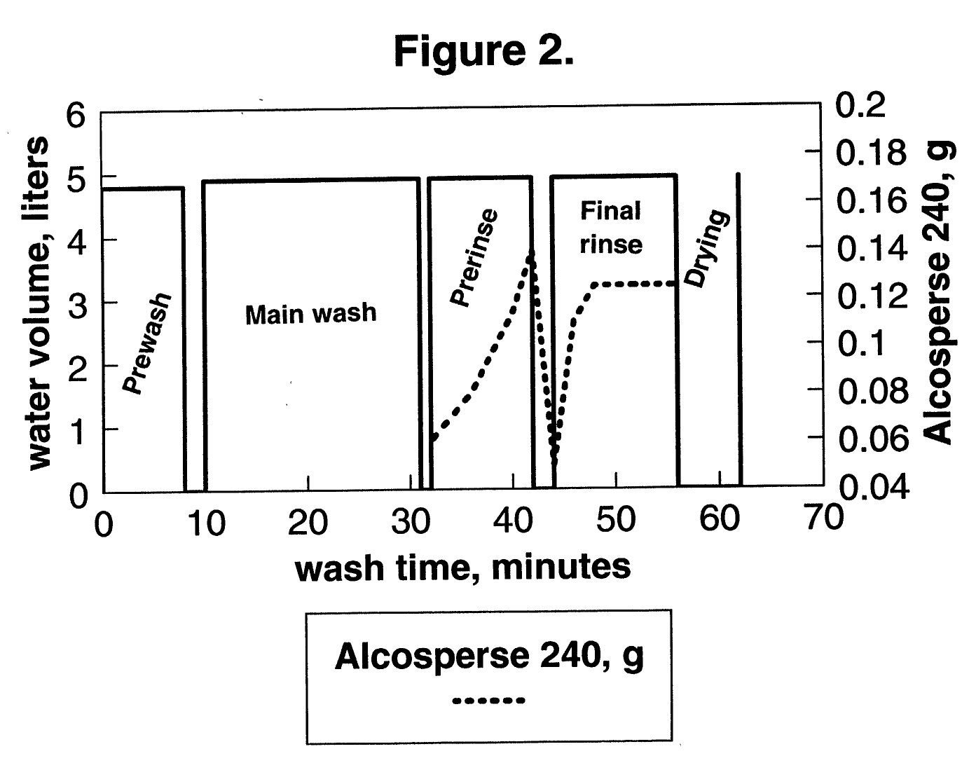

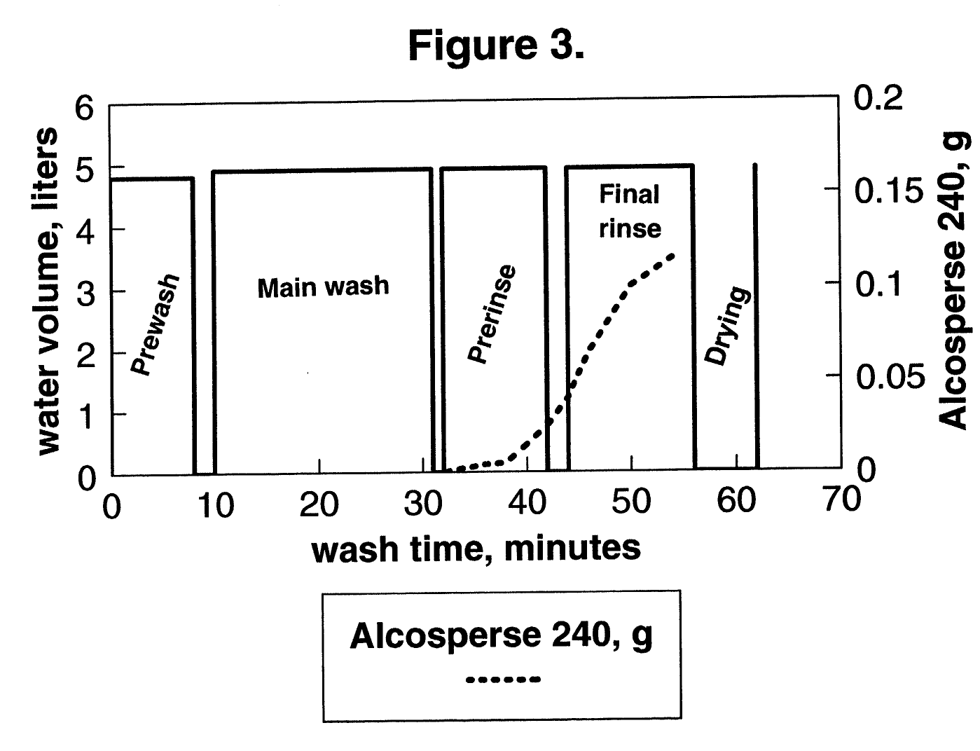

The data in FIG. 2 and FIG. 3 show the inhibitor levels delivered by certain of the tested surfactant core tablets during the pre-rinse and final rinse cycles. The inhibitor levels were measured by collecting a small amount of wash liquor and measuring the inhibitor content by UV spectroscopy.

Pluronic® F108, F98 and Tetronic® 1307 delivered the inhibitor into both of the pre-rinse and the final rinse water as shown in FIG. 2. Subsequently, the glass filming score was improved. However, Pluronic® F87 and Tetronic® 1107 co-tableted core tablets dissolve too slowly, so that inhibitor release is delayed past the pre-rinse, into the start of final rinse (FIG. 3), which is not the optimum delivery profile.

As demonstrated in the above example, when certain nonionic Pluronic® and Tetronic® surfactants (sample 2 to sample 4) were used as co-tableting agents for a scale inhibitor containing core tablet, the scale inhibitor was efficiently delivered to the rinse water and the filming score was improved.

### EXAMPLE 3

This example demonstrates a second possible route to achieving the optimum delivery profile of the scale inhibitor, as a component of a rinse cycle composition, described in Example 1, via compression coating. This example route employs a wax with a melting point of 57° C. as a co-tableting agent for a core tablet containing the rinse cycle composition. This core tablet is included inside of a main tablet.

0.10 g of wax was mixed with 0.15 g Alcosperse® 240 (the scale inhibitor) and pressed into a tablet with a diameter of 13 mm using a Spex X-press (Model 3624B). This core tablet was included in the center of a main tablet which has the composition shown in Table 1. The core tablet is introduced prior to compaction of the surrounding powder and then the whole mixture is pressed into a 34 mm diameter main tablet. The same experimental conditions were employed as in Example 2 except that 5 consecutive runs were carried out in this example. Each run constituted the execution of a complete machine dishwashing program with a fresh main tablet which always contained the core tablet. The same set of glass tumblers was left in the washing machine for the duration of the test. Two sets of similar tests were conducted as controls. One set of control tests was conducted with a main tablet containing 0.1 g wax only as the core tablet, i.e. without Alcosperse® 240. The other set of control tests was conducted with the main tablet containing 0.15 g Alcosperse® 240 only in the core, i.e. without wax.

The following filming scores were obtained:

Glass Filming Score

| | Wax + Alcosperse ® | | Alcosperse ® 240 |
|---|---|---|---|
| Minitablet | 240 | Wax Only | Only |
| Run 1 | 1.5 | 3.0 | 2.5 |
| Run 2 | 1.8 | 3.0 | 2.5 |
| Run 3 | 1.5 | 3.5 | 2.5 |
| Run 4 | 1.5 | 3.5 | 2.5 |
| Run 5 | 1.5 | 4.0 | 2.5 |

As demonstrated in this example, the scale growth via multiple washes is controlled by using a wax/inhibitor core tablet included inside the main tablet so as to give the most efficient delivery of antiscalant. The concentration of Alcosperse® 240 at the end of the penultimate and final rinses was determined (by collecting a small amount of wash liquor and measuring the inhibitor content by UV spectroscopy) to be 0.05 g and 0.067 g, respectively, for the Wax+Alcosperse® 240 case. The Alcosperse® 240—only core tablet dissolved completely in the main wash and thus did not deliver antiscalant into either of the penultimate or final rinses.

### EXAMPLE 4

This example demonstrates a third possible route to achieving the optimum delivery profile of the scale inhibitor, as a component of a rinse cycle composition, described in Example 1. This example employs a wax with a melting point of 57° C. as a co-tableting agent for the middle layer of a three layer tablet. The outer layers of the three layer tablet are comprised of a main wash cycle composition as given in Table 1. One half the total weight of the composition in Table 1 was compressed into a 34 mm diameter tablet using a Spex X-press (model 3624B). Then 0.33 g of wax was mixed with 0.70 g of Alcosperse® 240 (scale inhibitor) and added to the die and compressed. Lastly, the second half of the main wash cycle composition was added and pressed to give the completed tablet.

The same experimental conditions were employed as in Example 2. A set of control test was conducted with a three layer tablet containing 0.70 g Alcosperse® 240 only as the middle layer, i.e. without wax. The following filming scores were obtained:

| | Alcosperse ® 240 Level | | Glass Filming |
|---|---|---|---|
| | Pre-Rinse | Final Rinse | Score |
| Wax plus AS 240 Middle | 0.25 g | 0.15 g | 1.8 |
| Layer | | | |
| AS 240 Only Middle Layer | 0.21 g | 0.02 g | 2.5 |

As demonstrated in this example, the three layer table effectively sustained the release of the scale inhibitor through the pre (penultimate) rinse and final rinse. The resulting filming score was improved with respect to a tablet whose middle layer dissolved completely prior to the final rinse.

### EXAMPLE 5

This example demonstrates a fourth possible route to achieving the optimum delivery profile of the scale inhibitor, as a component of a rinse cycle composition, described in Example 1. The scale inhibitor is incorporated into a solid block. Such a solid block contains a co-binder or a solidification aid that serves to maintain the block in solid form throughout the machine dishwashing cycle. Most importantly, the co-binder or solidification aid serves to control the dissolution of the incorporated rinse cycle composition so that the copolymer component is delivered into the penultimate and the final rinse cycles. 3.8 g of Alcosperse® 240 was mixed with 38 g of a co-melted blend having the composition shown in Table 2. The whole mixture was then solidified by cooling to room temperature. A solid block was prepared as a control without adding Alcosperse® 240.

TABLE 2

| Ingredient | % Weight |
|---|---|
| Fatty Alcohol EO/PO Condensate (C16, EO-5, PO-4) | 54.1 |
| Polyethylene Glycol (Carbowax, EO-100 moles) | 40.1 |
| Fatty Acid Ethanolamide (C12) | 4.4 |
| Water | 1.5 |

Machine dishwashing experiments were carried out under the following conditions using a Bosch model 6082 dishwasher: 55° C.; Economy cycle, 400 ppm water hardness as CaCO₃. Ten clean glass tumblers were uses as wash articles, loaded into the top rack of the dishwasher.

The solid block is attached to the top rack of the dishwasher and remains in the machine for the whole wash cycle. During the main wash cycle, a STP-built tablet composition commercially available in Europe was added. The composition of this tablet is shown in Table 1.

The following filming scores were obtained:

| | Glass Filming Score |
|---|---|
| +Alcosperse ® 240 | 1.5 |
| −Alcosperse ® 240 | 2.5 |

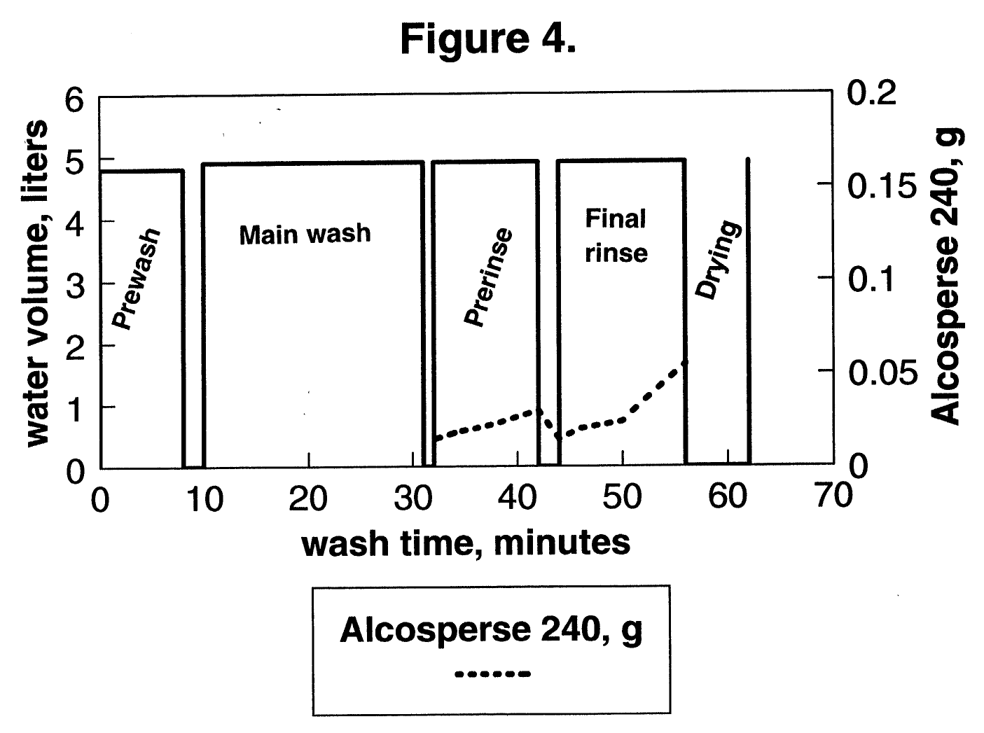

The solid block delivered the inhibitor into both of the pre-rinse and the final rinse water as shown in FIG. 4. Subsequently, the glass filming score was improved. As demonstrated in this example, the solid block is an effective means of delivering the scale inhibitor into both of the pre (penultimate) rinse and the final rinse water with the resulting benefit in filming.

### EXAMPLE 6

This example demonstrates a fifth possible route to achieving the optimum delivery profile of the scale inhibitor, as a component of a rinse cycle composition, described in Example 1. The scale inhibitor is incorporated at a high level in a tablet as an intimate mixture with the main wash cycle detergent and is also present in a second tablet designed to release into the final rinse.

Alcosperse® 240, at levels of 0.0, 1.0, or 1.5 g, was combined with the composition shown in Table 1 and pressed into a single 34 mm diameter tablet, using a Spex X-press (Model 3624B) delivering 2 tons of pressure. 0.50 g of a wax having a melting point of 57° C. was mixed with 0.0 or 0.4 g of Alcosperse® 240 and pressed to give a second tablet with a diameter of 13 mm. Machine dishwashing experiments were carried out under the following conditions using a Bauknecht model GSF 4741 dishwasher: 50° C. Bio Eco cycle, 500 ppm water hardness as CaCO₃. Five clean glass tumblers were used as wash articles, loaded into the top rack of the dishwasher. A test consisted of 5 consecutive machine dishwashing programs with both a 34 mm and a 13 mm tablet being loaded into the dispenser cup of the dishwashing machine at the start of each program. After the fifth run, the glass tumblers were visually graded on the scale described in Example 1. The level of anti-scalant polymer in 34 and 13 mm tablet, the concentration of polymer in the final rinse, as well as the subsequent glass filming score, are indicated below. The splitting of the anti-scalant between the main wash tablet and a wax tablet which delivers into the final rinse is clearly superior to putting the entire anti-scalant dose into the main wash. Correspondingly, the presence of anti-scalant in the main wash, and carried over into the penultimate rinse, delivers a definite benefit on top of anti-scalant delivered through the wax tablet into the final rinse.

| | | Measured | | |
|---|---|---|---|---|
| | | Alcosperse ® | | |
| Alcosperse ® 240 Dosage | | 240 Level in | | |
| 34 mm Tablet | 13 mm Tablet | Final Rinse | | Glas Filming Score |
| 0.0 g | 0.0 g | 0.0 | g | 4.0 |
| 1.5 g | 0.0 g | 0.0 | g | 3.0 |
| 1.0 g | 0.4 g | 0.04 | g | 1.0 |
| 0.0 g | 0.4 g | 0.05 | g | 2.0 |

The foregoing description and examples illustrate selected embodiments of the present invention. In light thereof variations and modifications will be suggested to one skilled in the art, all of which are within the spirit and purview of this invention.

What is claimed is:

1. A mechanical dishwashing composition comprising:
(A) an anti-scaling polymer formed from
(i) 50-99% by weight of the polymer of an olefinically unsaturated carboxylic monomer;
(ii) 1 to 50% of at least one monomer unit selected from the group consisting of copolymerizable sulfonated monomers, copolymerizable nonionic monomers and mixtures thereof;
(B) 0.1 to 99.9% of a vehicle releasing at least an effective amount to prevent scaling of the polymer into a penultimate rinse cycle of a dishwashing sequence to prevent scaling.

2. The composition according to claim 1 wherein the polymer has a weight average molecular weight ranging from about 1500 to about 250,000.

3. The composition according to claim 1 further comprising releasing at least an effective amount to prevent scaling of the polymer into a final rinse of the dishwashing cycle.

4. The composition according to claim 3 wherein the polymer is released in a relative weight ratio of about 1:10 to about 10:1 in the penultimate and the final rinse, respectively.

5. The composition according to claim 4 wherein the ratio is about 1:5 to about 5:1 for release in the penultimate and the final rinse, respectively.

6. The composition according to claim 5 wherein the ratio is about 1 for release in the penultimate and the final rinse, respectively.

7. The composition according to claim 1 wherein the olefinically unsaturated carboxylic monomer is in acid or salt form selected from the group consisting of monocarboxylic acids, dicarboxylic acids, polycarboxylic acids and mixtures thereof.

8. The composition according to claim 7 wherein the aliphatic acids are monoolefinic acrylic acids containing a substituent selected from the group consisting of hydrogen, halogen, hydroxyl, C₁-C₂₀ alkyl, C₆-C₁₂ aryl, C₆-C₁₆ aralkyl, C₇-C₁₆ alkaryl, C₅-C₁₅ cycloaliphatic radicals and mixtures thereof.

9. The composition according to claim 1 wherein the sulfonated monomers are compounds in acid or respective salt form selected from the group consisting of allyl hydroxypropanyl sulfonate ether, allylsulfonic acid, methallylsulfonic acid, styrene sulfonic acid, vinyl toluene sulfonic acid, acrylamino alkane sulfonic acid, allyloxybenzene sulfonic acid, 2-alkylallyloxybenzene sulfonic acids and mixtures thereof.

10. The composition according to claim 1 wherein the nonionic monomers are vinyl or allyl compounds selected from the group consisting of C₁-C₆ alkyl esters of (meth) acrylic acid, acrylamide, C₁-C₆ alkyl substituted acrylamides, N-alkyl-substituted acrylamides, N-alkanol-substituted acrylamides and N-vinyl pyrrolidone.

11. The composition according to claim 1 wherein the polymer is a tetra polymer of sodium methallyl sulfonate, acrylic acid, methyl methacrylate and 4-sulfophenol methallyl ether, the ether having a formula:
CH₂=C(CH₃)CH₂OC₆H₄SO₃M
where M represents hydrogen, alkali metal, alkaline earth metal or ammonium ions.

12. A method for washing soiled dishes comprising charging a mechanical dishwashing composition to a wash liquor in a washing machine, the composition comprising:
(A) an anti-scaling polymer formed from
(i) 50-99% by weight of the polymer of an olefinically unsaturated carboxylic acid monomer;
(ii) 1 to 50% of at least one monomer unit selected from the group consisting of copolymerizable sulfonated monomers, copolymerizable nonionic monomers and mixtures thereof;
(B) 0.1 to 99.9% of a vehicle releasing at least an effective amount to prevent scaling of the polymer into a penultimate rinse cycle of a dishwashing sequence to prevent scaling.
